(19) United States
(12) Patent Application Publication
(10) Pub. No.: US 2006/0253366 A1
(43) Pub. Date: Nov. 9, 2006

(54) Reverse auction system and method

(76) Inventor: Daniel T. Rebibo, Potomac, MD (US)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 11/121,259

(22) Filed: May 3, 2005

(51) Int. Cl. G06Q 40/00

(52) U.S. Cl. 705/37

(57) ABSTRACT

An apparatus and method for implementing a reverse auction comprising steps of gathering a first set of personal information from at least one buyer of goods or services, creating a second set of personal information based on the first set of personal information, disposing the second set of personal information on an electronic medium coupled to a network, permitting sellers of goods or services to offer bids to the buyer, and disclosing the first set of personal information to only the winning seller.

### FIELD OF THE INVENTION

This present invention relates to a computer-implemented auction system and method, and in particular, to a reverse auction system and method where sellers of services make bids to buyers of goods and services.

### BACKGROUND OF THE INVENTION

Computer-implemented auction systems are known and are widely implemented on the World Wide Web (WWW). Examples of websites which provide on-line auction systems include Ebay (www.ebay.com) and Priceline (www.priceline.com).

One form of computer-based auction is the so-called ‘reverse auction’ where the price of the product or service being auctioned decreases during the time period of the auction (as opposed to a regular auction where the price increase over time). Reverse auctions typically take place over a very short period of time, with a flurry of activity in the last portion of the auction process. U.S. Pat. No. 5,890,138 to Godin et al. describes a reverse auction process, and is incorporated herein by reference.

U.S. Pat. No. 6,385,594 (the “'594 Patent”) and U.S. Pat. No. 6,611,816 (the “'816 Patent”) assigned to LendingTree, Inc., and incorporated herein by reference, describe an on-line method of coordinating a loan over the Internet which bears some similarities to an on-line auction. In the described method, persons seeking loans (e.g., home mortgages) enter their personal information on a website pages or series of pages, and such information is filtered and relayed to a series of lenders.

FIG. 1 of both the '594 and '816 Patents illustrates the ten general stages in the process required to coordinate an electronic credit application between a prospective borrower and a plurality of lenders. For example, in stage 1 the process presents background information and a credit application to a prospective borrower on a web site. In stage 2, the prospective borrower inputs information into the web site. In stage 3, validation checks are performed on this information to make sure that the application is complete and correct. Next, stage 4 involves storing and manipulating the credit application in a database. In stage 5, a Fair Isaac Credit Score is obtained based upon the credit application and that score is matched to the application and stored in the database. Next, in stage 6, the application is filtered where it is compared to a list of criteria presented by a series of lending institutions. If the application passes this list of criteria then in stage 7 the application is sent to each one of those institutions whose criteria match with the application. In stage 8 the lender processes the application and can either accept or deny it. If the lender accepts the application then in stage 9, the borrower can reply stating whether he accepts or denies the lender's terms. Finally, in stage 10, information about this transaction is sent to a database to allow lending institutions to have access to their lending history.

However, it will be noted that in the method described in the '594 and '816 Patents, it is the lending institutions which are in control of virtually the entire process. For example, if borrower is approved by five (5) or more lending institutions, he must still contact all of them to obtain their respective terms (e.g., lending rate, closing cost approximation, etc.) in order to make a final decision on one of them. Because the five lenders will no doubt compete with one anther for the borrower's business, the borrower will also be forced to negotiate optimal terms as between the five lenders. This means calling or otherwise contacting each lender multiple times. This contact and negotiation process is almost always time consuming, and most borrowers would be happy to eliminate this step if possible.

Thus, there is presently a need for an on-line auction in which sellers of goods or services (e.g., lenders) can provide bids to a buyer of goods or services (e.g., borrowers), wherein only bids which are more optimal than an initial bid are displayed to the buyer, and only the chosen seller of goods or services may receive the buyer's personal information.

### SUMMARY OF THE INVENTION

An exemplary embodiment of the present invention comprises a method for implementing an auction including the steps of gathering a first set of personal information from at least one buyer of goods or services, creating a second set of personal information based on the first set of personal information, disposing the second set of personal information on an electronic medium coupled to a network, permitting sellers of goods or services to offer bids to the buyer and, disclosing the first set of personal information to only the winning seller.

Another exemplary embodiment of the present invention comprises a computer system including at least one server computer; and, at least one user computer coupled to the at least one server through a network, wherein the at least one server computer includes at least one program stored therein, the program performing the steps of gathering a first set of personal information from at least one buyer of goods or services, creating a second set of personal information based on the first set of personal information, disposing the second set of personal information on an electronic medium coupled to a network, permitting sellers of goods or services to offer bids to the buyer; and, disclosing the first set of personal information to only the winning seller.

Another exemplary embodiment of the present invention comprises a computer readable medium having embodied thereon a computer program for processing by a machine, the computer program including a first code segment for gathering a first set of personal information from at least one buyer of goods or services, a second code segment for creating a second set of personal information based on the first set of personal information, a third code segment for disposing the second set of personal information on an electronic medium coupled to a network, a fourth code segment for permitting sellers of goods or services to offer bids to the buyer and, a fifth code segment for disclosing the first set of personal information to only the winning seller.

Another exemplary embodiment of the present invention comprises a computer data signal embodied in a carrier wave including a first code segment for gathering a first set of personal information from at least one buyer of goods or services, a second code segment for creating a second set of personal information based on the first set of personal information, a third code segment for disposing the second set of personal information on an electronic medium coupled to a network, a fourth code segment for permitting sellers of goods or services to offer bids to the buyer and, a fifth code segment for disclosing the first set of personal information to only the winning seller.

Another exemplary embodiment of the present invention comprises a method for implementing an auction including the steps of permitting at least one seller of goods or services to offer an initial bid to at least one buyer of goods or services, allowing the at least one seller, and one or more other sellers, to view the initial bid, permitting the at least one seller and the one or more other sellers to offer one or more additional bids and allowing the at least one seller and the one or more other sellers to view each additional bid.

### BRIEF DESCRIPTION OF THE DRAWINGS

FIG. 1 is a block diagram showing a computer system according to an exemplary embodiment of the present invention.

FIG. 2 is a flow diagram showing a method for executing a reverse auction according to an exemplary embodiment of the present invention.

### DETAILED DESCRIPTION

The present invention comprises, in one exemplary embodiment, a system and method for a computer-implemented auction. The system preferably comprises a client-server computer network, as is well known in the art, and as described below. As also discussed below, the system executes the auction method through software resident on at least one of the computers of the client-server network. The auction method preferably comprises a 'reverse'auction in which a plurality of sellers are bidding to a single buyer. The sellers preferably compete with each other to generate the lowest possible bid, and thus the optimal terms for the buyer.

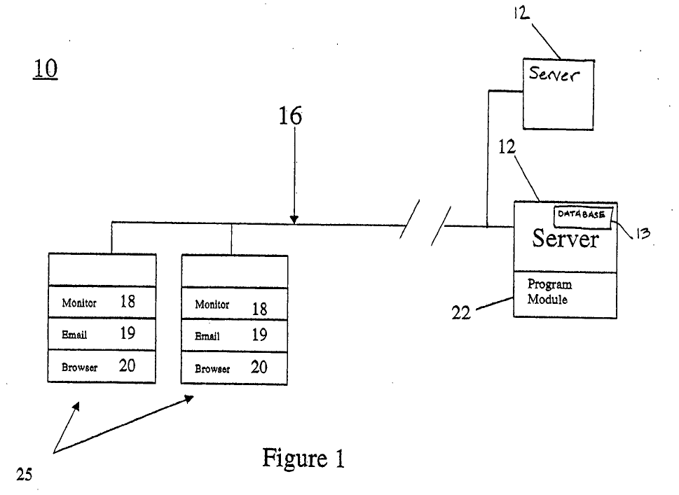

FIG. 1 shows a client-server computer system 10 according to an exemplary embodiment of the present invention. The computer system 10 includes a plurality of server computers 12 and a plurality of user computers 25 (clients). The server computers 12 and the user computers 25 may be connected by a network 16, such as for example, an Intranet or the Internet. The user computers 25 may be connected to the network 16 by a dial-up modem connection, a Local Area Network (LAN), a Wide Area Network (WAN), cable modem, digital subscriber line (DSL), or other equivalent connection means.

Each user computer 25 preferably includes a video monitor 18 for displaying information. Additionally, each user computer 25 preferably includes an electronic mail (e-mail) program 19 (e.g., Microsoft Outlook®) and a browser program 20 (e.g. Microsoft Internet Explorer®, Netscape Navigator®, etc.), as is well known in the art.

One ore more of the server computers 12 preferably include a program module 22 (explained in detail below) which allows the user computers 25 to communicate with the server computers and each other over the network 16. The program module 22 may include program code, preferably written in Hypertext Mark-up Language (HTML), JAVA™ (Sun Microsystems, Inc.), Active Server Pages (ASP) and/or Extensible Markup Language (XML), which allows the user computers 25 to access the program module through browsers 20 (i.e., by entering a proper Uniform Resource Locator (URL) address). The exemplary program module 22 also preferably includes program code for facilitating an on-line reverse auction method among the user computers 25, as explained in detail below.

At least one of the server computers 12 also includes a database 13 for storing information (e.g., personal information regarding a plurality of users) utilized by the program module 22 in order to carry out the on-line reverse auction. Although the database 13 is shown as being internal to the server in FIG. 1, those of ordinary skill in the art will realize that the database 13 may alternatively comprise an external database. Additionally, although database 13 is shown as a single database in FIG. 1, those of ordinary skill in the art will realize that the present computer system may include one or more databases coupled to the network 16.

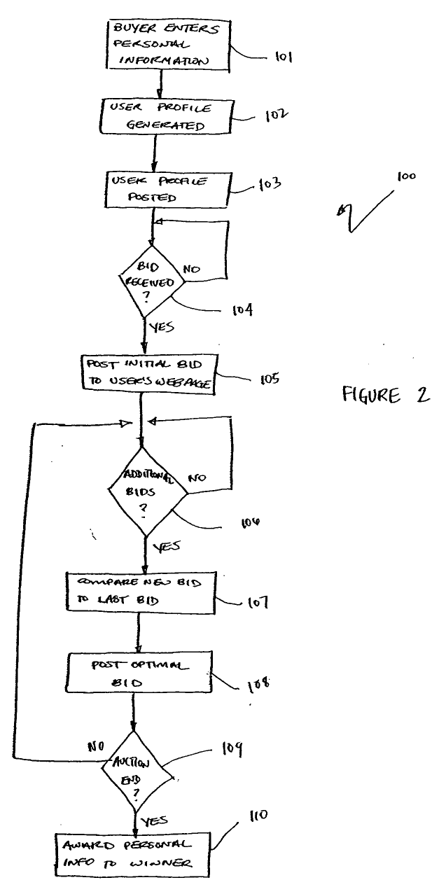

FIG. 2 shows a method for implementing a reverse auction 100 which includes a first step 101 of a buyer entering personal information (e.g., name, address, phone number, e-mail address, salary, etc.) into one of the user computers 25 connected to the network 16. Once entered, the personal information is preferably transmitted over the network 16 to one or more of the server computers 12 where it is stored in one or more databases 13. The personal information entered by the buyer at this stage is preferably comprehensive (i.e., it includes detailed contact information), but only a portion of this personal information is revealed to bidding sellers who do not win the auction, as explained in detail below.

In step 102 of the method 100, a user profile is created from the personal information entered in step 101. The user profile is preferably generated by one or more of the server computers 12 and stored in one or more databases (13) coupled to the server computer. In an exemplary lender (seller)-borrower (buyer) embodiment of the present method, the user profile may include information such as loan type (e.g., 30 year fixed, 5 year ARM, etc.), dollar amount of loan (e.g., $200,000.00), property location (e.g., 1313 Mockingbird Lane), property purchase price (e.g., $250,000.00), down payment (e.g., $50,000.00), and basic credit information (e.g., household salary and monthly debts). The user profile would not include personal contact information such as the borrower's name, address, telephone number, or e-mail address.

Continuing on to step 103 of the method 100, the user profile is posted to a centralized website on the network 16, which is accessible by one or more of the user computers 25 (e.g., www.loanbid.com). The website may be administered by one or more persons who will be referred to herein collectively as the “web site operator.” Preferably, the user profile is posted by one or more of the server computers 12, and is accessible by selected ones of the plurality of user computers 25 over the network 16. For sake of clarity, the foregoing discussion will focus only on a method implemented via an Internet/World Wide Web-type network, although those of ordinary skill in the art will realize that the method has application in various network environments (e.g., Intranets, etc.).

Steps 102 and 103 are carried out for various users stationed at the user computers 25 who enter personal information, so that a plurality of user profiles are generated and posted to the Internet by one or more of the server computers 12. As each user profile is generated and posted, sellers stationed at other user computers 25 have the ability to view the user profiles and select particular users to which to offer bids. In the lender-borrower exemplary embodiment, the sellers would comprise lending institutions providing bids on loan terms to individual borrowers.

Once at least one user profile has been posted at step 103, sellers of goods or services (e.g., lenders) may make bids for goods or services to each individual user who has a user profile at step 104. Sellers are preferably stationed at one or more of the user computers 25 connected to the same network (16) as the buyers described above. The content of the bid is preferably directly related to the information in the user profile, and the type of goods or services the buyer has requested. In the exemplary lender-borrower embodiment, the bid may include the loan period, annual percentage rate (APR) and estimated closing costs (e.g., 30 year fixed, APR=4.5%, $2000.00 estimated closing costs). Alternatively, the bid may include only the APR in the exemplary lender-borrower embodiment.

The first seller to bid to a particular buyer creates an 'initial'bid which is preferably posted to a web page on the Internet to which the buyer and competing sellers have exclusive access. For example, each buyer may have his or her own web page which is accessed through a ‘USERID’ and ‘PASSWORD’ type protocol, on which certain information regarding the goods or services (e.g., loan type, property address, etc.), and the current optimal bid are displayed. Similarly, each seller would have a separate ‘USERID’ and ‘PASSWORD’ for accessing the system and various buyer web pages.

At step 105 of the method 100, the initial bid is posted to the specific user's web page. As noted above, once this initial bid is posted, other sellers may view the bid and submit additional bids in an attempt to beat the initial bid and win the auction. The initial bid may be underbid by the sellers stationed at other user computers 25 on the network 16. For example, in the exemplary lender-borrower embodiment, if the initial bid is as noted above (30 year fixed, 4.5%, $2000.00), another seller may ‘beat’ that bid by offering a loan with terms such as 30 year fixed, 4.25%, $1500.00. Sellers may continue to make bids against one another indefinitely, or until the expiration of a predetermined time period. Preferably, the buyer chooses the bidding time period when entering his or her personal information at step 101. Alternatively, the operator of the present system 10 and method 100 may choose the bidding period to be the same for all users.

During the bidding process, the optimal bid is viewable by both the buyer (e.g., borrower) and the other sellers (e.g., lenders) on the monitors 18 of their respective user computers 25. If a particular seller wishes to change the bid during the bidding process (i.e., offer something better), he can change the bid by entering information for a new bid (e.g., term, APR, estimated closing costs) at his client computer, and selecting to transmit the bid to the server computer for posting (by, for example, clicking on an “BID” dialog box displayed on his monitor).

Once the bidding has been concluded, the winning seller (i.e., the seller with the optimal bid), receives the remainder of the buyer's personal information (e.g., name, address, phone numbers, e-mail address, etc.). At this point the winning seller can contact the buyer directly to inform him of the terms of the bid and finalize the transaction. In the lender-borrower exemplary embodiment, the lender will contact the borrower to coordinate closing of the loan. As will be evident to those of ordinary skill in the art, the winning seller may receive the buyer's personal information through various means, including e-mail, web page posting, standard mail, etc. In order to provide security for the buyer's personal information (if provided electronically), those of ordinary skill in the art will understand that a password protection scheme, encryption scheme, or other equivalent protection means could also be provided in conjunction with the delivery personal information. Additionally, a ‘click-through’ license may also provided which would prohibit the winning seller from using the buyer's personal information for purposes other than completing the transaction on which the auction was based (i.e., the winning seller could not sell the buyer's personal information to others).

Returning to FIG. 2, at step 106, the process determines whether additional bids have been received. If at least one additional bid has been received (subsequent to the initial bid), the additional bid is compared to the initial bid at step 107 to determine if the additional bid offers better terms than the initial bid (e.g., lower APR, lower closing costs, etc.). If the additional bid offers better terms, the additional bid is posted to the user's website at step 108, thus replacing the initial bid. The process then determines if the auction has closed at step 109. If the auction remains open, the process proceed back to step 106 to see if there are any additional bids, and if there are, repeats steps 107-109.

This bidding process continues until the auction period ends at step 109. At the end of the auction, the winning seller is determined, and the user's personal information (e.g., name, address, telephone numbers, e-mail address, etc.) is awarded to the winning seller at step 110.

After the buyer's personal information is awarded to the winning seller, the user and the winning seller can separately coordinate the conclusion of the transaction (e.g., closing of a loan commitment, purchase of an automobile, etc.). Once the transaction has been completed (or if the transaction was not completed for some reason), the buyer may optionally rate his or her experience with the seller. For example, in the lender-borrower embodiment described above, the borrower can rate his or her satisfaction with the lender and the closing process (or in ability to close due to problems with the lender). In this way, each seller utilizing the system is given a ‘rating’ which may be observed by other future buyers during the bidding process, and used in determining whether or not to accept a bid from that seller.

In the case of a transaction which has closed, the seller may communicate the closing by notifying the operator of the web site, which will prompt communication with associated buyer to perform a rating. In the case of a transaction which has not closed (presumably due to some act or omission of the seller), the buyer may communicate the failure of the closing to the operator of the webs site, which will prompt communication from the web site operator to the buyer to perform a rating. These various communications between the seller, web site operator and buyer may take place over e-mail, for example. The ‘rating’ process may comprise a short questionnaire which is completed by the buyer and transmitted via e-mail to the web site operator for posting on the associated web site, and for associating with the rated seller for use in future transactions. For example, rating levels between one (1) and (5) may be established, and a seller's aggregate rating may be displayed along with the seller's bid during the auction (e.g., if the seller received three ratings of “1,” “3,” and “5,” the seller's aggregate rating would be “3”). In this manner, if a certain seller has received an aggregate rating which is low (e.g., “1”), the buyer may elect to receive no bids from that seller, or disqualify any such bids received.

The above-described method 100 allows sellers to view each other's bids and compete with one another to provide the best possible terms for the buyer. Particularly, by allowing other sellers to see each other's bids, competition is increased and the buyer achieves the best possible terms. Additionally, in some cases, this allows smaller and lesser-known sellers to compete with larger and well-known sellers for business (i.e., by forcing the sellers to compete with each other on terms only and not reputation, the seller with the best terms is rewarded). In the lender-borrower example, lenders will be encouraged to lower their APR bid (and thus their commission) in order to secure a larger volume of business. For example, if a lender offers a 1.5% commission on an APR of 5.75% to its mortgage brokers, but only a 1.25% commission on an APR of 5.5%, the brokers may be incentivized to offer the lower APR if they believe it will lead to a larger volume of business (i.e., five loans closed at a 1.25% commission is better than four loans closed at 1.5%).

Thus, the method 100 increases competition and at the same time generates optimal terms for the buyer because the respective sellers can see directly what each other is offering (as opposed to hearing it second hand from the buyer). The method 100 also makes the buyer's experience more pleasant, as he does not have to waste time engaging in back-and-forth negotiations with multiple sellers (e.g., lenders/mortgage brokers) to obtain the optimal terms.

Although an exemplary embodiment of the present invention has been described above with regard to a lender-borrower auction process for a home mortgage, those of ordinary skill in the art will realize that the present system and method had application in various other transactions, such as (1) automobile purchases, (2) insurance policy purchases, (3) automobile loans, (4) purchase of electronics or appliances, (5) prescription drug purchases, (6) purchase of mattresses, (7) hotel reservations, (8) purchase of medical equipment, (9) purchase of airline tickets, (10) financing of student loans, etc.

In the case of an automobile purchase, automobile dealerships would tender competing bids for a particular automobile to a potential automobile purchaser. Similarly, in the case of insurance policies, various insurance agents would tender competing bids for monthly premiums for a particular type of insurance (e.g., automobile, life, health, etc.). The case of automobile loans is similar to the home mortgage lender-borrower arrangement discussed above, except that the bids would focus on only on loan amount and APR (as closing costs are typically not involved in an automobile loan). In the case of electronics or appliances, retailers of such merchandise (e.g., Best Buy, Circuit City, Target, etc.) would tender competing bids for a particular item (e.g., a Toshiba® 57″ widescreen television). Finally, in the case of prescription drugs, various pharmacies would tender competing bids to fills particular prescriptions (e.g., a prescription for 20 tablets of Celebrex®).

Although the invention has been described in terms of exemplary embodiments, it is not limited thereto. Rather, the appended claims should be construed broadly to include other variants and embodiments of the invention which may be made by those skilled in the art without departing from the scope and range of equivalents of the invention.

What is claimed is:

1. A method for implementing an auction comprising the steps of:
gathering a first set of personal information from at least one buyer of goods or services;
creating a second set of personal information based on the first set of personal information;
disposing the second set of personal information on an electronic medium coupled to a network;
permitting sellers of goods or services to offer bids to the buyer; and, disclosing the first set of personal information to only the winning seller.

2. The method of claim 1, wherein the electronic medium comprises a computer.

3. The method of claim 1, wherein the network comprises the Internet.

4. The method of claim 1, wherein the seller of goods or services comprises a lending institution.

5. The method of claim 4, wherein the buyer of goods or services comprises a borrower.

6. The method of claim 1, wherein the seller of goods or services comprises an automobile dealership.

7. The method of claim 6, wherein the buyer of goods or services comprises an automobile purchaser.

8. The method of claim 1, wherein the seller of goods or services comprises a pharmacy.

9. The method of claim 8, wherein the buyer of goods or services comprises a prescription drug purchaser.

10. The method of claim 1, wherein the seller of goods or services comprises an insurance agent.

11. The method of claim 10, wherein the buyer of goods or services comprises an insurance purchaser.

12. The method of claim 1, wherein the seller of goods or services comprises an electronics retailer.

13. The method of claim 12, wherein the buyer of goods or services comprises an electronics purchaser.

14. The method of claim 1, wherein the seller of goods or services comprises an appliance retailer.

15. The method of claim 14, wherein the buyer of goods or services comprises an appliance purchaser.

16. The method of claim 1, wherein the second set of personal information comprises information on the term and annual percentage rate of a loan.

17. The method of claim 1, wherein the second set of personal information comprises information on the term, estimated closing costs and annual percentage rate of a loan.

18. The method of claim 1, wherein the first set of personal information comprises name and contact information for the buyer of goods or services.

19. The method of claim 1, wherein the winning seller is determined to be the seller which has offered the most optimal bid at the end of the auction.

20. The method of claim 1, wherein the step of permitting sellers of goods and services to offer bids to the buyer comprises the steps of:
accepting an initial bid from a first seller of good or services;
comparing a first subsequent bid from the first seller or another seller to the initial bid to determine if the first subsequent bid is more optimal for the buyer than the initial bid; and, replacing the initial bid with the first subsequent bid if the first subsequent bid is more optimal.

21. The method of claim 20, wherein the step of permitting sellers of goods and services to offer bids to the buyer comprises the further steps of:
(a) accepting one or more additional bids from the first seller or another seller after the first subsequent bid;
(b) comparing each of the one or more additional bids to the first subsequent bid to determine if the any of the one or more additional bids are more optimal for the buyer than the first subsequent bid;
(c) replacing the first subsequent bid with one of the one or more additional bids, if one of the one or more additional bids is more optimal than the first subsequent bid or any of the other one or more additional bids; and,
repeating steps (a)-(c) until the termination of the auction.

22. The method of claim 1, comprising the further steps of:
permitting the at least one buyer of goods or services to rate one or more sellers; and,
displaying a seller's aggregate rating to other buyers.

23. A computer system comprising: at least one server computer; and, at least one user computer coupled to the at least one server through a network, wherein the at least one server computer includes at least one program stored therein, said program performing the steps of:
gathering a first set of personal information from at least one buyer of goods or services;
creating a second set of personal information based on the first set of personal information;
disposing the second set of personal information on an electronic medium coupled to a network;
permitting sellers of goods or services to offer bids to the buyer; and, disclosing the first set of personal information to only the winning seller.

24. A computer readable medium having embodied thereon a computer program for processing by a machine, the computer program comprising:
a first code segment for gathering a first set of personal information from at least one buyer of goods or services;
a second code segment for creating a second set of personal information based on the first set of personal information;
a third code segment for disposing the second set of personal information on an electronic medium coupled to a network;
a fourth code segment for permitting sellers of goods or services to offer bids to the buyer; and,
a fifth code segment for disclosing the first set of personal information to only the winning seller.

25. A computer data signal embodied in a carrier wave comprising:
a first code segment for gathering a first set of personal information from at least one buyer of goods or services;
a second code segment for creating a second set of personal information based on the first set of personal information;
a third code segment for disposing the second set of personal information on an electronic medium coupled to a network;
a fourth code segment for permitting sellers of goods or services to offer bids to the buyer; and,
a fifth code segment for disclosing the first set of personal information to only the winning seller.

26. A method for implementing an auction comprising the steps of:
permitting at least one seller of goods or services to offer an initial bid to at least one buyer of goods or services;
allowing the at least one seller, and one or more other sellers, to view the initial bid;
permitting the at least one seller and the one or more other sellers to offer one or more additional bids;
allowing the at least one seller and the one or more other sellers to view each additional bid; and,
awarding personal information about the at least one buyer to the at least one seller with the most optimal bid at the end of the auction.

27. The method of claim 26, comprising the additional steps of:
replacing the initial bid with one of the additional bids, if the terms of the one additional bid are more favorable for the buyer than the terms of the initial bid;
allowing the at least one seller and the one or more other sellers to view only the one additional bid.

28. The method of claim 26, wherein the seller of goods or services comprises a lending institution.

29. The method of claim 26, wherein the seller of goods or services comprises an automobile dealership.

30. The method of claim 26, wherein the seller of goods or services comprises a pharmacy.

31. The method of claim 26, wherein the seller of goods or services comprises an insurance agent.

32. The method of claim 26, wherein the seller of goods or services comprises an electronics retailer.

33. The method of claim 26, wherein the seller of goods or services comprises an appliance retailer.

34. The method of claim 26, comprising the further steps of:
permitting the at least one buyer of goods or services to rate one or more sellers; and,
displaying a seller's aggregate rating to other buyers.
